(19) United States
(12) Patent Application Publication
(10) Pub. No.: US 2010/0011309 A1
(43) Pub. Date: Jan. 14, 2010

(54) DATA VISUALISATION SYSTEMS

(75) Inventors: Subhobrata Mitra, Coventry (GB); Xinuo Chen, Coventry (GB)

Correspondence Address: BARNES & THORNBURG LLP, P.O. BOX 2786, CHICAGO, IL, 60690-2786, US

(73) Assignee: The University of Warwick, Coventry (GB)

(21) Appl. No.: 12/374,144

(22) PCT Filed: Jul. 17, 2007
(86) PCT No.: PCT/GB07/02684

§ 371 Date: Jan. 16, 2009

(30) Foreign Application Priority Data
Jul. 17, 2006 (GB) 0614156.8

(51) Int. Cl. G06F 3/048

(52) U.S. Cl. 715/768; 715/771; 715/848; 715/853

(57) ABSTRACT

A method in a computer of building a visual representation model for presenting plural forms of data from a data source to a user, comprising the steps of creating a first file of data (model file) representative of one or more physical attributes of one or more elements associated with one of a plurality of nodes in the visual representation, creating a second file of data (configuration file) representative of visual attributes of the one or more elements for each of the plurality of nodes in the visual representation and associating a variation in the visual appearance of the nodes in correlation with variation in the data from the data source which is associated with the nodes.

The invention relates to the field of data visualisation. In particular, the invention provides a system and method of visualising plural forms of data by a user thereby better to allow comparison of different sets of data through an enhanced graphical user interface. The invention also provides a method and system for building a model for visualising data and an interactive user interface for viewing the data once the model is built.

It is known to represent data in visual forms such as graphs and moreover, it is known to visualise plural forms of data in a visual manner using a glyph such as disclosed in U.S. Pat. No. 6,232,984. In that prior art document, the focus is on providing a comparison of the data for different processes in a larger project.

The visual representation for each project comprises a glyph having several components each of which represents a different type of data and each glyph therefore being comparable with adjacent glyphs and/or superimposable on top of other glyphs to enable comparison, through the relative appearance of the glyphs.

A problem with prior art visualisation systems is that they do not easily enable comparison of plural sets of data because for example of the complex nature of the multiple components of the glyph described in U.S. Pat. No. 6,232,984. Accordingly, the invention seeks to provide suitable forms of visualisation to enable a user readily to grasp the significance in any differences or trends in datasets through an improved data visualisation system, method and user interface. Moreover, the invention seeks to provide a visualisation system which is adapted to enable a user to build a model which might for example be created by a super user for use by lower level users in analysing different or changing datasets.

The graphical user interface according to the present invention is a step innovation over existing visualisation tools such as reports, dashboards and graphs. It uses the human brain's exceptional ability to track changes in the properties of objects scattered in space. It has been developed through research in the limits and possibilities of visual search, cognition and interactive graphics.

In essence, the present invention provides a system and method of data visualisation which enables a super user to build an appropriate model including graphical representations of a system (such as retail outlets located at different geographical regions, components making up a mechanical system, and so on) in a visual manner, and associate variables within a dataset to one or more properties of the objects (nodes) in the model, and moreover, enable a lower level user to analyse the data through the data visualisation system and also to interact with the data for example to provide different forms of graphical information based on any discernable trends through observance of variations in visual properties of objects in the graphical representations of a system through e.g. a primary model.

An important aspect of the invention is the ability of the super user to build the model through a unique graphical user interface enabling different graphical methods of positioning objects (nodes) within the model so as to define a representation of a three dimensional array of objects (nodes). Further, the invention provides for multiple data series corresponding to performance characteristics of a multi-part organisation or system to be viewed through changes in the visible properties of a three dimensional model. The model can reflect a manager's mental map of the business or system process. It allows users to build the three dimensional model, assign data series from an existing data source to its various elements, and stipulate criteria according to which data values would be shown as changes in visual properties such as colour, transparency, size and movement for example. Most importantly, this build process is interactive on the user's primary GUI or desktop and does not require any software authoring. Since the three dimensional model and the data connections are encapsulated in a separate (configuration) file, endless bespoke visualisation applications can be built on the fly by different users.

Moreover, the system allows users to interactively view a set of data series as changing visual properties of objects (nodes) in the three dimensional model, move around over the values of the ‘series’ variable (eg., time) using a (time) slider and see how events relate and follow each other across various elements of the three dimensional model of the business process of interest. Subsets of data in problem locations or time periods can be extracted into charts and spreadsheets.

According to an aspect of the invention there is provided a method of building a visual representation model for presenting plural forms of data from a data source to a user, comprising the steps of creating a first file of data (model file) representative of one or more physical attributes of one or more elements associated with one of a plurality of nodes in the visual representation, creating a second file of data (configuration file) representative of visual attributes of the one or more elements for each of the plurality of nodes in the visual representation and associating a variation in the visual appearance of the nodes in correlation with variation in the data from the data source which is associated with the nodes.

Beneficially by creating a first and second file of data, a user is able to provide a visible model for viewing data from the data source which might for example comprise an array of nodes representative of different locations of business entities such as retail stores, or which might represent different components in a machine such as a vehicle engine. Having built the first file of data (model file) the user is then able to retain this and use it for different purposes for example in viewing the variation of different variables (such as sales values or component wear) over different parameters (such as time and/or mileage) since different configuration files can be created whereby the data associated with the elements on each node can be changed and modified by a user thereby to give greater variation in the viewing and hence appreciation of changes in data throughout the data source.

Preferably, the data source can comprise first and second categories of types of data wherein the second category (or upper level) might be representative of location such that the first (lower) category might then be, store, city, or nation for example (but equally the upper level category might be machine such as a type of engine and the lower level category might be components for that engine). Within each category then the data for one or more variables associated with the lower category is stored in the data source wherein the data for a variable, being a range of data across a parameter (such as time or date or mileage), is known for one or more of the lower categories thereby enabling comparison of the variables for the different lower categories in a visual representation of the data according to the method of the invention.

Further features and further aspects of the invention are defined in the appended claims.

Embodiments of the invention will now be described, by way of example only, with reference to the accompanying drawings, in which:

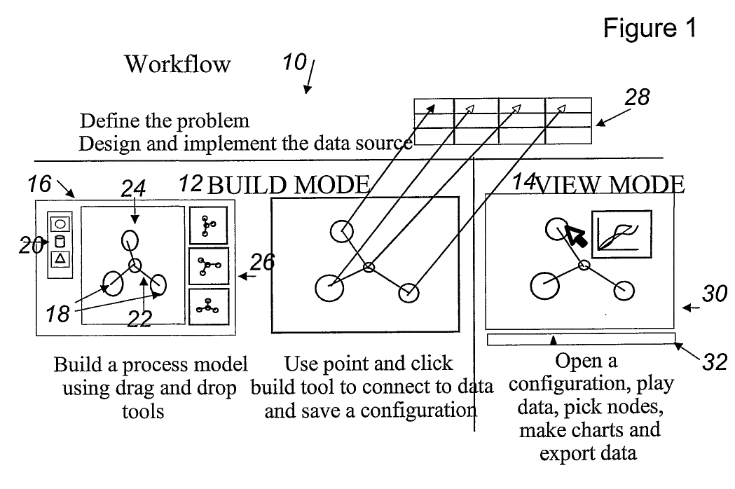

FIG. 1 is a schematic overview of the overall workflow process according to the invention;

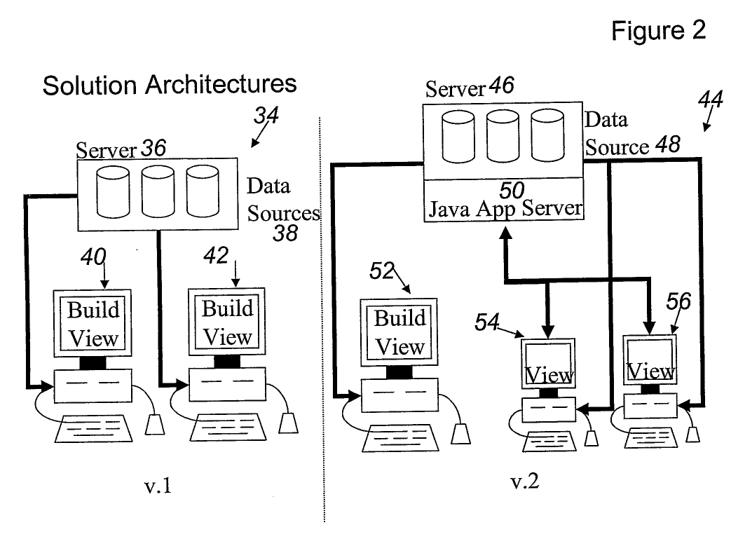

FIG. 2 is a schematic block diagram of the features according to two versions of the invention;

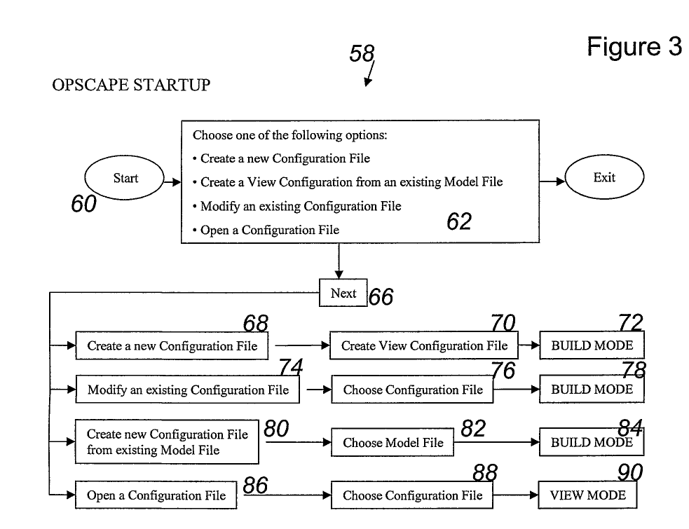

FIG. 3 is a schematic block diagram of the start up process of a method according to the invention;

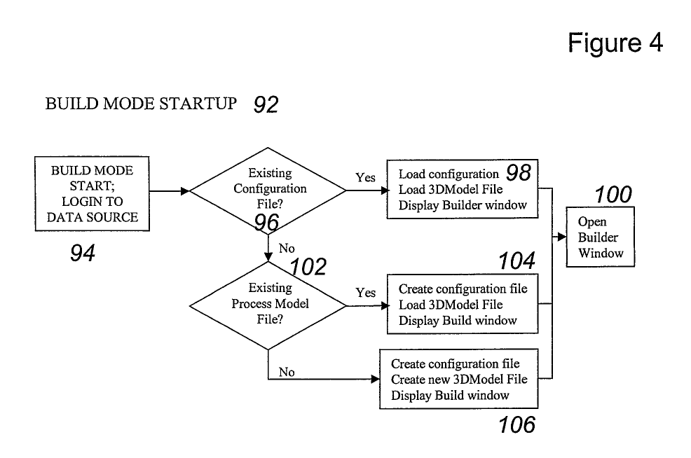

FIG. 4 is a schematic block diagram of the start up process of the build mode according to the invention;

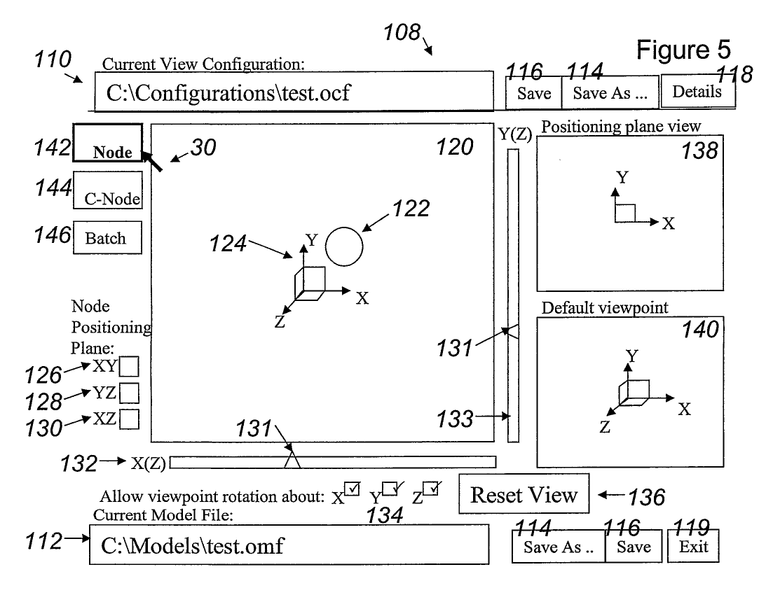

FIGS. 5 to 13 are schematic representations of views at different steps in the build process;

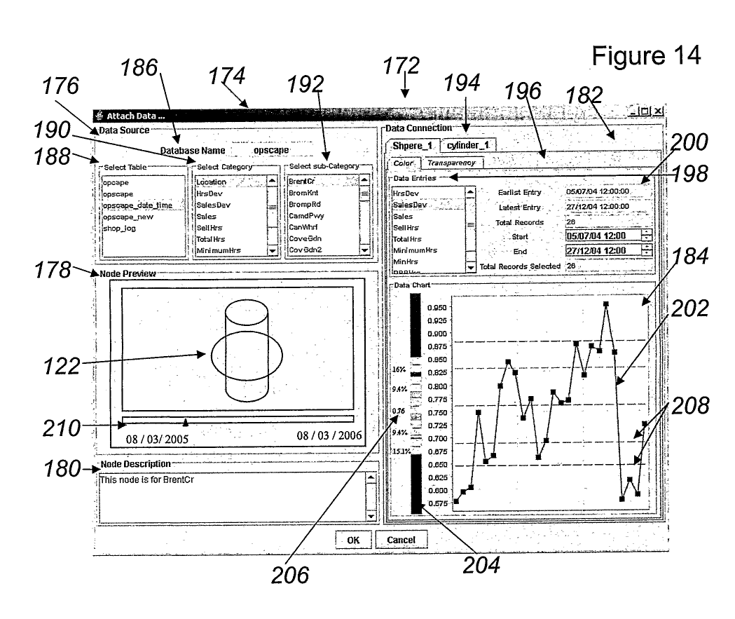

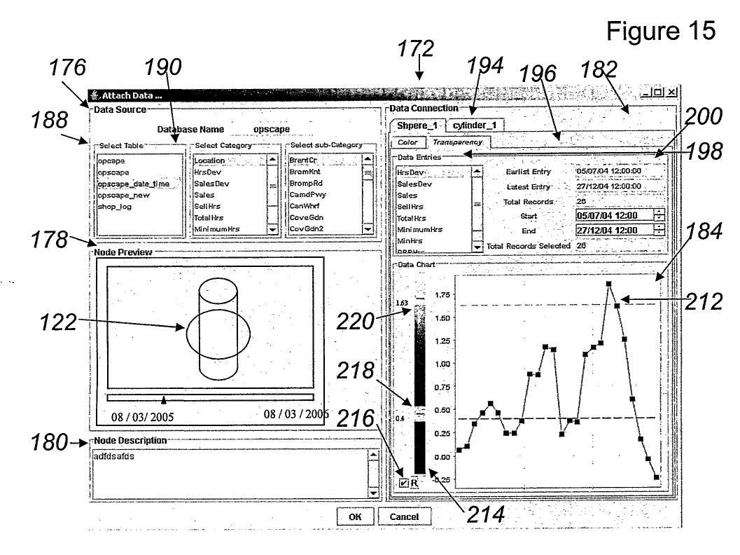

FIGS. 14 and 15 are a view showing the display which shows association of upper and lower categories, as well as variable data with elements associated with a node in the build mode;

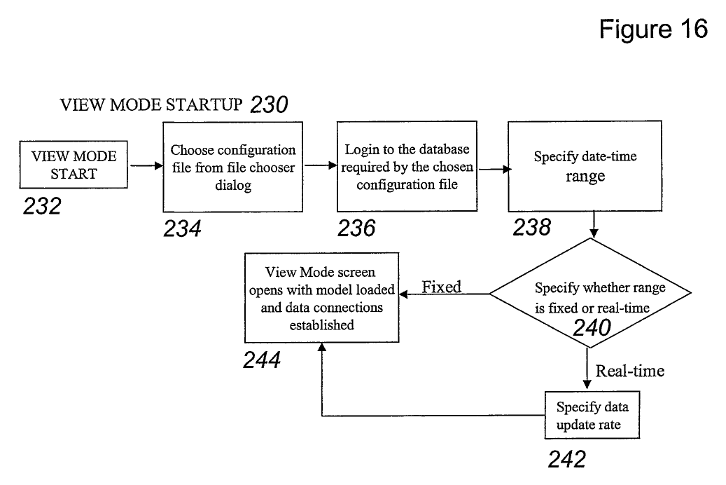

FIG. 16 is a schematic diagram of the start up process for the view mode;

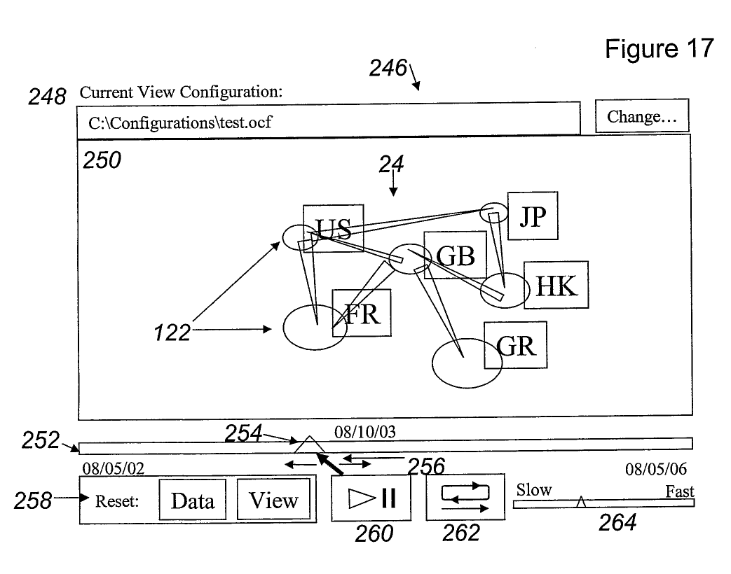

FIGS. 17, 18 and 19 are views of arrays of data available in the view mode;

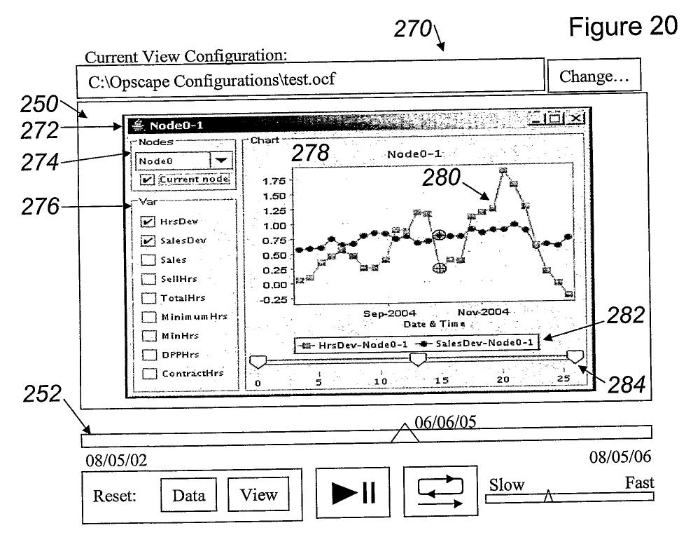

FIG. 20 a view of data which can be extracted into a chart in the view mode; and

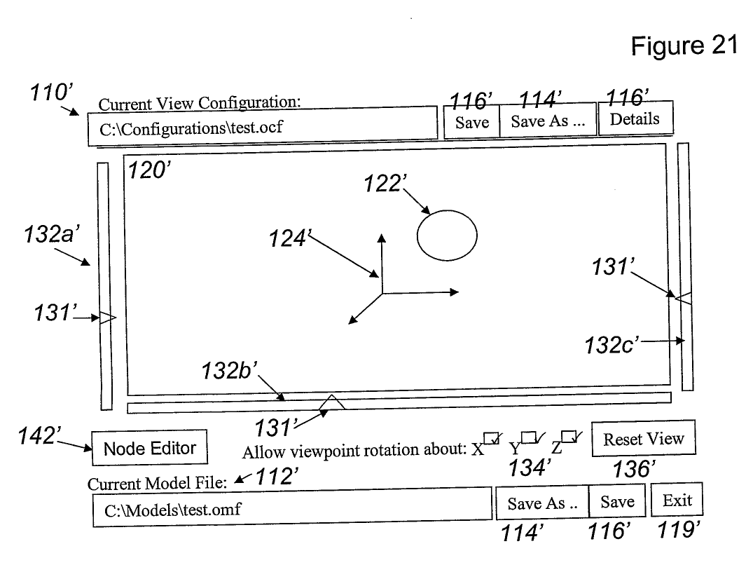

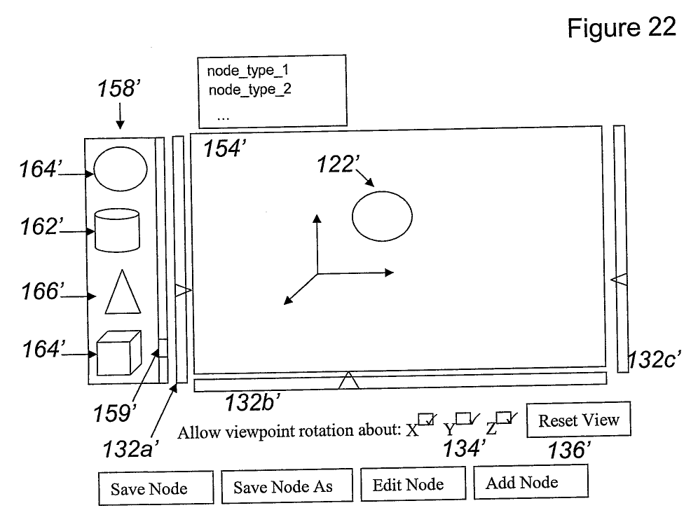

FIGS. 21 and 22 are an alternative embodiment to that shown in FIGS. 5 to 13.

FIG. 1 is a schematic representation of the workflow process 10 involved in enabling the improved visualisation of data according to the invention. The workflow process 10 comprises a build mode 12 and view mode 14.

In outline, with reference to FIG. 1, the workflow process or method 10 comprises a build mode 12 which enables a user to interact with a computer system via a graphical user interface 16, which comprises for example a computer monitor and a mouse, in order to locate nodes (or objects) 18 within a 2D representation of a a 3D model. In the first of the two build mode views shown, four nodes 18 are shown in the central part of the view which nodes each have an associated shape selected from the shape buttons 20 shown in the left hand side of the view. The nodes 18 can be interconnected via a connecting rod 22, and form an array 24 of nodes (in which not all nodes need to be interconnected and indeed some nodes can be connected to several other nodes). The array 24 is also displayed from different perspectives in separate 2D representations of the 3D model as shown in the two smaller views 26 on the right hand side (though the number of views can be varied and for example only two views might be provided as described later). In the second image of build mode 12 in FIG. 1, each of the nodes is associated with a field of data in a set of data 28. Beneficially, the association can be through the use of a point and click system through the graphical user interface, as described in more detail later on.

The workflow process 10 further comprises a view mode 14 which enables a user to vary the views of data through a graphical user interface in order to interact with the system thereby to enable the display of variations in the visualisation of the data for example using a cursor 30 to interact with nodes of interest and/or to interact with a time bar 32 (or other variable parameter). The method also allows a user easily to view data in other forms such as graphically in order to compare data and to better determine trends or anomalies.

Referring to FIG. 2 there is shown version 1 and version 2 of solution architectures for a system according to the invention. In version 1, the system 34 comprises a server 36 having one or more data sources 38 for example held in memory within a computer forming server 36. The server 36 can act as a network server linking one or more client stations in the form of personal computers 40 and 42 for example. Accordingly, the personal computers 40 and 42 have access to the data source 38 via server 36 and are able to perform the build function described in outline in relation to FIG. 1. In version 2, the system 44 comprises a server 46 having one or more data sources 48 and a network application server 50 (eg Java or .Net) enabling interaction via a network to 3 different network clients 52, 54 and 56, wherein network client (or work station) 52 can comprise a full user application enabling both build, rebuild and view modes whereas network clients 54 and 56 are suitable for users requiring only the view mode which might be achieved through a web browser application interacting with application server 50.

Referring to FIG. 3 there is shown a block diagram of the startup sequence 58 of an application according to the invention.

At step 60, a user starts the application and at step 62, the user chooses one of the options of creating a new configuration file, creating a view configuration from an existing model file, modifying an existing configuration file, and opening a configuration file. A model file is simply a description of the 3D world made up of a number of nodes, with some geometry (ie elements or shapes) at each node. The file lists the node locations in co-ordinates, and the geometry elements associated with each node (including their position, orientation and size). The model file also includes values of the various visual properties of geometry elements of each node, as shown in the model file structure. These properties preferably have default values given at the time of model building, and the default values are then overridden by the data attachment criteria specified by the configuration file in conjunction with which the model file happens to be viewed.

A configuration file defines how the visual properties of the geometry elements stored in a model file are animated by the values of variables taken from a data source. A configuration file contains the name of the 3D model file to load, the name and location of the data source to connect to, which variables to connect to which visual property of which geometry element of the 3D model, and what criteria to use to transform the variable values into visual parameter changes. A schematic of the structure of a model file and a configuration file are provided below:

### Model File Structure

Node number
Name
Geometry
   Position co-ordinates, x, y, z
   Orientation co-ordinates, u, v, w
Default Properties
   Diffusive colour, c1, c2, c3
   Specular colour, s1, s2, s3
   Transparency, t
   Dimensions, d1, d2,

Node number
Name
Geometry
x, y, z
u, v, w
Default Properties
   Diffusive colour, c1, c2, c3
   Specular colour, s1, s2, s3
   Transparency, t
   Dimensions, d1, d2, . . .

### Configuration File Structure

Database name

Model file name, URL

Node 1
Geometry1
   Visual property, database variable, mapping criteria
   . . . , . . . , . . .
   . . . , . . . , . . .
Geometry2
   . . . , . . . , . . .

In the build mode a user is able to create or modify a model file and a configuration file whereas in the view mode a user is able only to load a configuration file (which in turn loads a model file), view the animated model and extract charts and data tables for locations and periods of special interest. This is seen in relation to FIG. 3 wherein the system detects at step 66 the user's request such that at step 68 a new configuration file is created if so requested by the user at step 62. The user is able to create a new model file at step 70 and operate the build mode as indicated at step 72. At step 74, the user modifies an existing configuration file if so requested at step 62, and then chooses the configuration file to modify as shown in step 76. The user then enters the build mode enabling further modification as indicated at step 78. At step 80 a user creates a new configuration file from an existing model file by associating data as described later. The user accordingly chooses the model file at step 82 and enters the build mode at step 84. At step 86, the user opens a configuration file and having chosen a configuration file at step 88 enters only the view mode at step 90, having selected only the “open a configuration file” option at step 62.

Referring to FIG. 4 there is shown a flow diagram of the build mode startup process 92. This is the sequence followed from any of the steps 72, 78 or 84 as shown in FIG. 3. At step 94, shown in FIG. 4, the build mode start requires the user to select the data source. At step 96 the user selects whether or not to use an existing configuration file if yes, at step 98 the system loads the configuration file, loads the model file and displays the builder window (shown later). The builder window is open at step 100. If the user chooses not to use an existing configuration file at step 96, then the user selects whether or not to use an existing process model file at step 102, if yes then at step 104 the system creates a configuration file, loads the model file and displays the window which is opened at step 100. If the user decides not to use an existing process model file at step 102, then the system creates a configuration file, creates a new 3D model file and displays the build window as indicated at step 106. Again, the open builder window step is indicated at step 100.

In the build mode, it is apparent that two files are essentially created to define the nodes, the physical attributes and visual appearances thereof. The physical attributes including the location, (eg in co-ordinates in the relevant view) number of elements (such as 1, 2 or 3) shape of elements (such as ball and/or rod for example), orientation of the elements (such as vertical, horizontal and so on), size of the elements, number of connectors, shape of connectors and connection attributes of connectors are defined within the model file for a plurality of nodes. The configuration file contains information associating fields of data from the data source with each of the nodes and in particular the visual attributes of the elements and connectors. Accordingly, every configuration file contains a reference to a model file but the model file can exist independently of a configuration file. A given model file can therefore be referenced by multiple configuration files. In a model file, the node positions and their geometry's are designed to reflect a user's mental map of the processes being modelled. This is then a special schematic of the process components and how they are related logically before the user.

Greater detail of the build mode is now given in relation to FIGS. 5 to 15, and greater detail of the view mode is given in relation to FIGS. 16 to 21.

Referring to FIG. 5, there is shown a build view 108 in a user interface forming part of a system according to the invention, wherein view 108 comprises a number of panels as follows. Firstly, the current view file configuration 110 is described providing the location of the file within the computer system, and the current model file 112 is similarly described by providing its location within the computer system as shown at the top and bottom of FIG. 5 respectively. Additional buttons include a save as button 114, a save button 116 (having the usual functionality both associated with the adjacent model file or configuration file) as well as a details button 118 which (provides a text window presenting configuration file information), as well as an exit button 119.

The user interacts with the system using cursor 30 to define nodes in the main panel 120 shown on the left of the view in FIG. 5. In this view a single node is provided at 122 and a co-ordinate axes symbol 124 is provided for assisting a user to position a node 122 in a 3D space which is viewed as the 2D representation provided in panel 120.

There are two primary ways of enabling accurate location of a node 122 within the three dimensional model using the two dimensional representations through the graphical user interface. The first relies on the use of the co-ordinate axes symbol 124 to enable a user to select the plane represented by the plane of the main panel 120 itself. By moving a cursor 30 and clicking over the appropriate plane, as designated by a colour square between the axes in the co-ordinate symbol 124 (such as red for XY, blue for XZ and green for YZ planes), the user is able to orient the view in the main panel 120 such that the axes perpendicular to the plane selected (eg the Z axes if the XY plane is selected) points perpendicularly to the screens on the computer monitor itself, and hence main panel 120 represents the XY plane enabling a user to position node 122 by clicking and dropping it in an appropriate position.

The second method does not change the view shown in the main panel 120 but enables selection of the plane in which the node is constrained to move through use of the boxes 126, 128 and 130 which indicate the XY, YZ and XZ planes respectively. Again, these can be colour co-ordinated for example with the XY being represented in red, YZ being represented by green and XZ being represented by blue as can be shown in the co-ordinate axes symbol 124. By selecting one of buttons 126, 128 or 130, the user is able accurately to locate the node 122 within the selected plane using sliders 131 on the appropriate axes 132 and 133 (which here are shown representing the X and Y axes). Beneficially, the user is able therefore to move accurately a node 122 within a plane being represented in whatever view is given in the panel 120 itself using sliders 131 along the perpendicular axes which define the plane whilst still having a three dimensional representation of the model shown within panel 120 (and as referenced against the co-ordinate axes symbol 124 (as shown in FIG. 5)).

Beneficially, panel 138 shows the two dimensional view with the third axis perpendicular to the panel 138 whilst default view point 140 shows how the model looks from a default position (the one or more nodes 122 being shown in both panels 138 and 140 during the building process). Preferably, when the build view 108 is first opened, panels 120 and 140 both show the model from a default viewpoint. Subsequently, as the user rotates the model in panels 120, 140 keeps on showing the default view. Thus, a lot of model building goes on with panels 120 and 140 having completely different viewpoint locations. The user can continue placing and moving nodes while viewing the model from arbitrary viewpoints in panel 120 while always having available panel 140 to show what the model is looking like from the default viewpoint. Clicking the Reset View button 136 brings 120 back to the default viewpoint.

Accordingly, nodes are added in the build mode as shown in FIG. 5 by selecting the node button 142 and positioning the node in the panel 120 in an interactive manner by the user via the graphical user interface system which relies on cursor 30 for example. Users can left click and drag (ie using a mouse or similar device) on the panel to rotate the model, middle click and drag to zoom the viewpoint in and out, or right click and drag to move the view point vertically or horizontally. The viewpoint rotation function can be limited to operate about 1, 2 or 3 axes (using buttons 134). The re-set view, achieved by depressing button 136, brings the panel in view 120 back to the starting view point set up (which might be as shown in default view point 140 for example). The bottom right panel always shows the model from the starting view set up. If a configuration file referring to this model is opened in view mode, the default view point will be the one shown in panel 140. Accordingly, it is important for the user to ensure that they are satisfied with what the whole model looks like (after building multiple nodes) from this view point. The top right panel 138 shows the model looking straight into the current node position plane.

When a user clicks the node button 142, a new node is placed in the model at a default location. The user changes the node position according to the first and second method described above that is selecting the location plane using symbol 124 or by moving along the X Y, Y Z or X Z plane in a 3D representation using buttons 126, 128 and 130. When the X Y position plane is selected (button 126) horizontal marker 131 controls the position along the X axes and vertical slider (or marker 131) controls the position along the Y axes. When the Y Z positioning plane is selected (button 128) the markers 131 in the horizontal and vertical interactive slider bars represent the Z and Y axes respectively whereas when the X Z positioning plane is selected (button 130) the horizontal and verticals interactive slider bars represent the X and Z axes respectively. Again, the top panel 138 shows the model looking straight into the current positioning plane of the main panel 120. Alternatively, the node position can be specified by a user inputting co-ordinate values x, y and z (as described later).

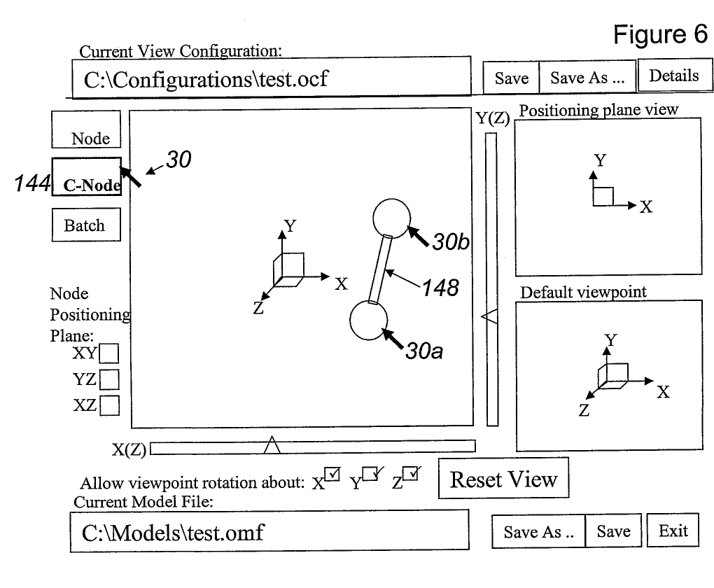

Referring to FIG. 6, there is shown the same user interface view 108 but having two separate nodes 122 interconnected by a connector bar 148. The connector bar is selected by a user using cursor 30 and connector node button 144 shown on the left hand side of FIG. 6. Beneficially, the connector is not positioned in a default position but rather the user clicks and drags the cursor 130 between a first and second node in order to provide a connector between them as shown schematically in relation to cursors 30A and 30B.

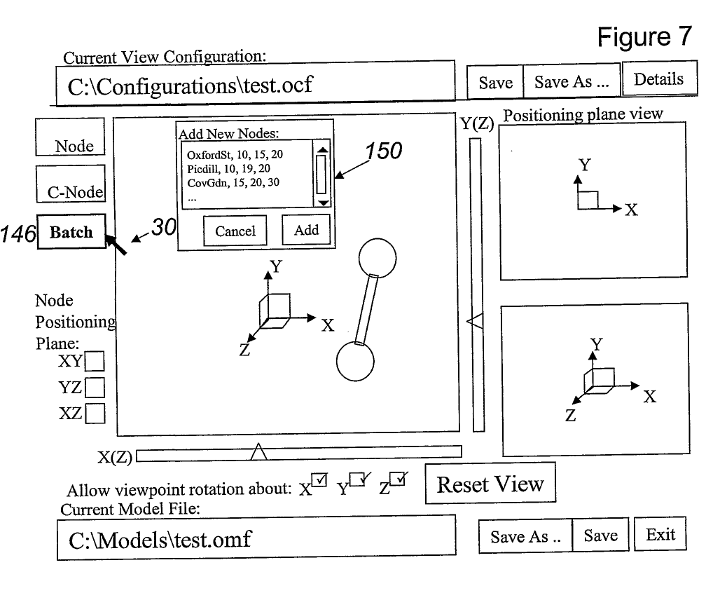

Referring to FIG. 7, users can use the batch button 146 to enable location of multiple nodes in the model as viewed in panel 120. This is achieved for example, using a dialogue box 150 to add new nodes. Accordingly, by clicking cursor 30 in the dialogue box 150, the user is able to define new nodes, firstly giving them a name (as shown by way of example here as Oxford Street, Piccadilly and Covent Garden) and then entering a three co-ordinate position (such as 10, 15 and 20 in relation to Oxford Street). By clicking the add button in dialogue box 150, the nodes can be added automatically to the model and hence displayed in panel 120.

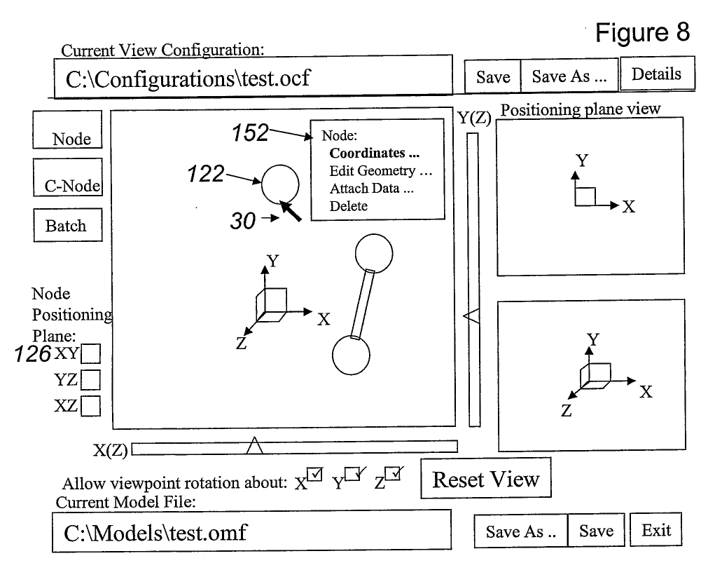

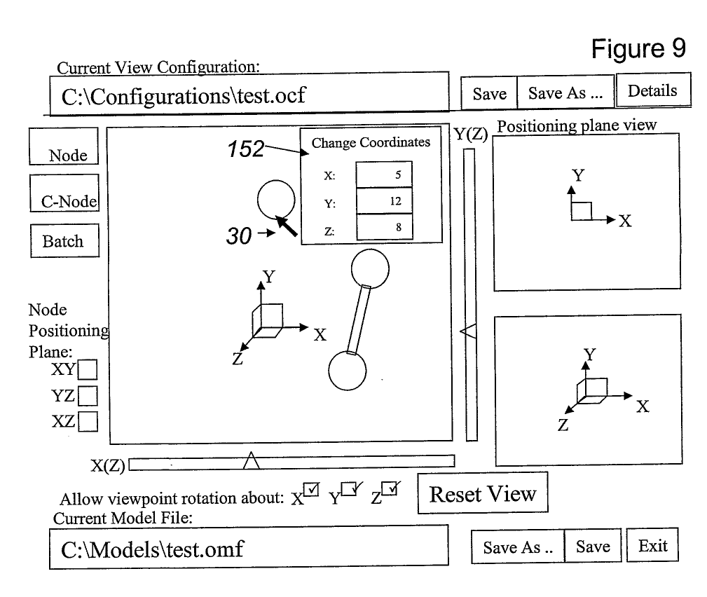

Referring to FIG. 8, the same user interface view 108 is shown for the build mode 12. In this view, a further node 122 is shown in main panel 120 over that shown in FIG. 7. Additionally, it can be seen that a user is able using cursor 30 and for example by depressing the shift button at the same time as left clicking on a node 122, the user is able to have a dialogue box 152 pop up in the panel 120. The dialogue box (or node pop up) 152 enables a user to select the nodes co-ordinates, add the geometry attach data and/or delete the node as can be seen in FIG. 8. By selecting the co-ordinates option in the dialogue box 152, the user is able to enter new co-ordinates for the X Y and Z axes as shown in dialogue box 152 in FIG. 9. Accordingly, at least three options are available to the user through the graphical user interface to enable a change of the data held in relation to a node within the build model, that is through the selection of the node and a node positioning plane using buttons 126, 128 and 130; location in a viewed plan in panel 120 using symbol 124 as described earlier; or more directly (rather than at a plane at a time) through a selection of the change co-ordinates option in dialogue box 152 as shown in relation to FIG. 9 (and hence typing in of co-ordinates x, y and/or z).

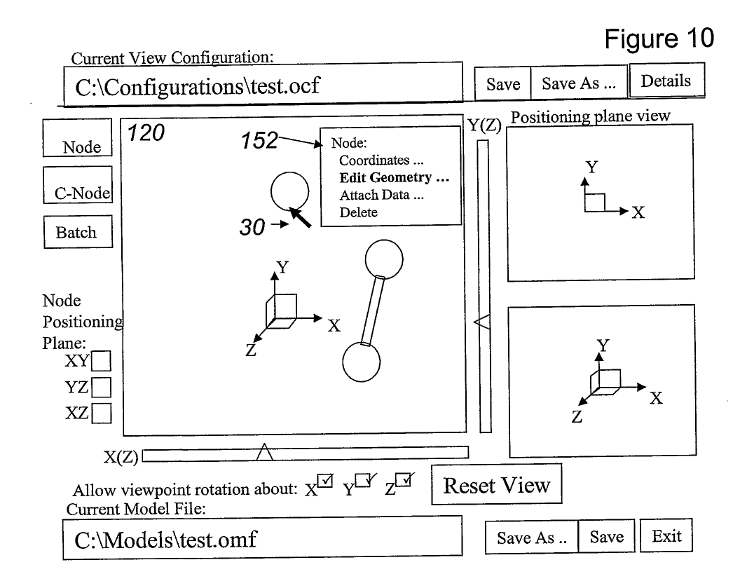

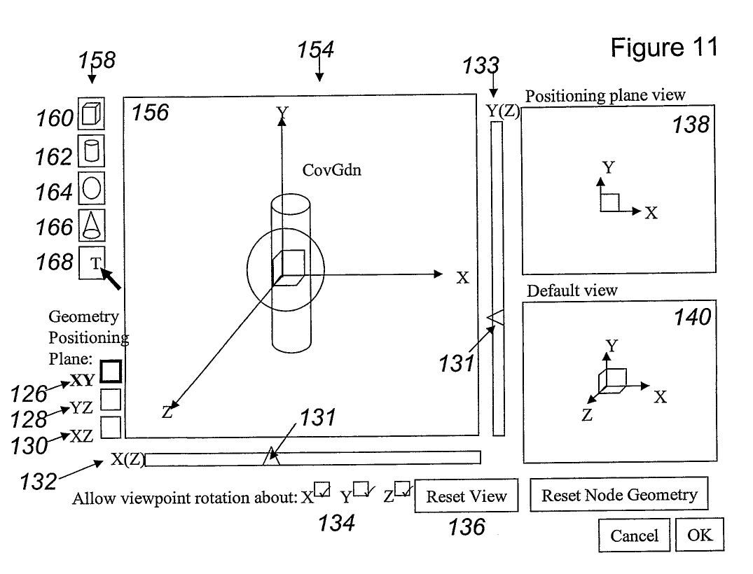

By selecting the edit geometry option in the dialogue box 152 in main panel 120, as shown in FIG. 10, a user is able to edit the geometry of a node selected using cursor 30. As shown in FIG. 11, the view in main panel 120 changes upon selection of the edit geometry option. In FIG. 11, there is shown a user display 154 where like components from the earlier view 108 are given the same reference numbers and for example X Y, Y Z and X Z planes selector buttons 126, 128 and 130 remain. However, additional buttons 158 are provided to enable variation of the geometry of each of the elements associated with a node. Here, a button 160 enables selection of a cube shape, button 162 enables selection of a cylinder, button 164 enables selection of a sphere and button 166 enables selection of a cone. A further button 168 enables selection of insertion of text associated with the node for example enabling a user to enter a name for reference purposes against the node as shown in FIG. 11 whereby the node is referred to as CovGdn for Covent Garden.

A node, being the item against which data is entered in the build model as comprising a location and associated elements, has a centre as can be seen in FIG. 11 at the juncture of the X Y and Z axes. Each node can have a number of one or more geometrical elements associated with it (each of which elements can represent a different type of data as discussed in outline earlier). To select the geometry of each of the elements (such as a sphere and cylinder, as shown in panel 156 for the Covent Garden node), the user simply clicks on the appropriate button such as buttons 162 and 164 whereby each of the elements is associated with the Covent Garden node and positioned in a default position e.g. with a centre on the node (being the juncture of the X Y and Z axes) and as shown in FIG. 11. The user is however able to click on each of the elements in panel 156 and to re-orientate and re-position the location of that element (being a geometrical shape) using the interactive bars 132 and 133 by sliding the markers 131 along the relevant axes represented by the associated interactive bar 132 or 133. Accordingly, by selecting a plane such as the X Y plane using button 126, the interactive bars 132 and 133 are assigned to the X Y axes respectively and as shown in FIG. 11) whereby the panel 138 shows this plane in plan view from the direction of the Z axes and the user is able to select the element by clicking on it and place it to an appropriate position in the X Y plane using the visual displays of panels 156, 138 and 140. An element can be selected by clicking on it and then highlight it in the view (for example by brightening the appearance of the element, providing a dashed outline to the element and/or flashing the element on or off at a suitable frequency) in order to ensure that the user moves the correct element. By clicking on an element a drop-down menu of data, e.g. position and orientation, can be presented to the user enabling editing thereof.

Preferably, the text information associated with the node is always presented in the correct orientation for the user to read it; that is parallel with the plane of the display panel itself, the orientation being independent of the viewing mode selected by the user such that the text is provided in what is known as “billboard” fashion.

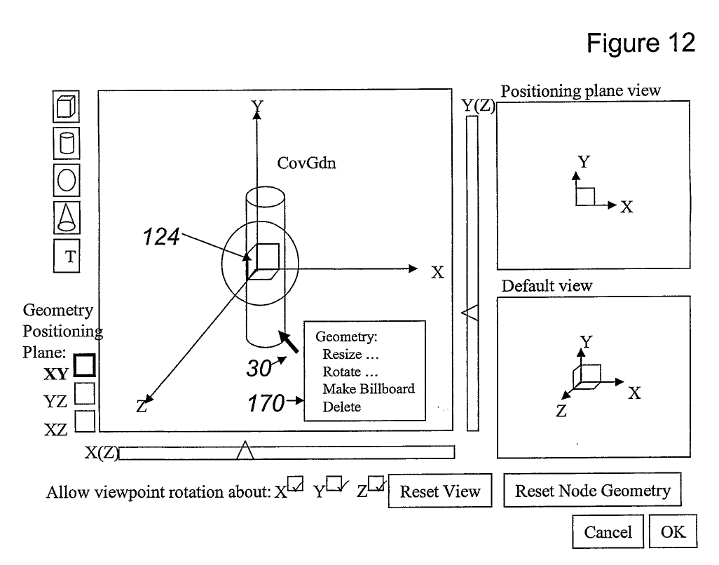

In an alternative editing mode, a user is able to press the “shift” key and hence by shift clicking using the interactive device which is a mouse to control the position of cursor 30 on the display, the user is able to bring up a dialogue box 170 to enable editing of an element including the elements geometry, to re-size the element, to rotate the element or to make the element in a form viewable by a user independent of the viewing direction in other words make the element “billboard” and/or to delete the element as indicated in the dialogue box 170 shown in FIG. 12. Accordingly, using the dialogue box 170, the user is able to change the geometry (or shape) of a selected element and to re-size the element such as for example two differently sized elements of the same geometry (such as spheres could be used to define different data associated with the same node) but this is not preferred. Similarly, by clicking on the rotate option in dialogue box 170, the user is able to rotate the orientation of an element such that the cylinder shown in FIG. 12 might be rotated from being parallel with the Y axes to being parallel with the X or Z axes for example.

The viewing position can be varied in the build mode again by selecting the graphical representations of the different planes (X Y, Y Z and X Y, shown at the juncture of the different X Y and Z axes at the core of the node in other words using the 3D representational symbol 124 of the planes in order select each of the planes as described earlier in relation to FIG. 5 for example), or by left click and drag to rotate the model as also described earlier.

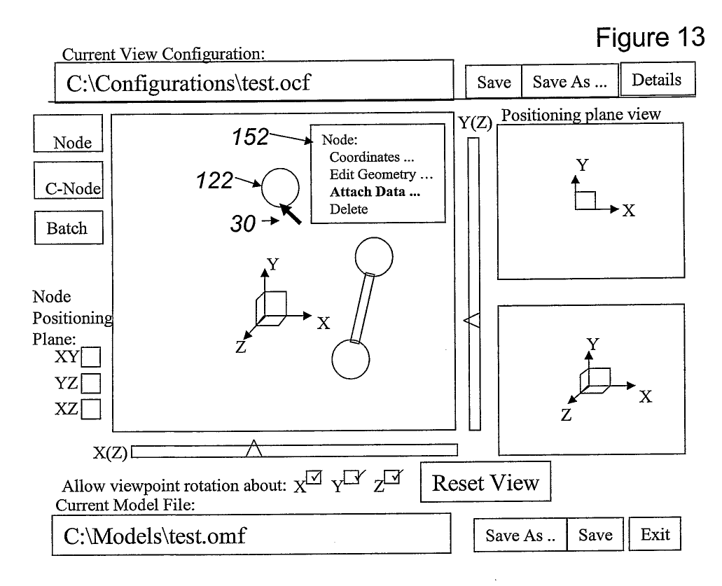

Referring to FIG. 13, a substantially similar view to that shown in FIG. 10 is provided. Here, a node 122 is selected using cursor 30 in order to bring up a dialogue box 152. Here however, the attached data option is selected. By so doing, a new view 172 comprising a panel 174 is shown to the user as shown in FIG. 14. As can be seen in FIG. 14, panel 174 comprises several sections including a data source section 176, a node preview section 178, a node description section 180, a data connection section 182 and a data chart 184. Using the data source section 176, the user is able to select the data source for this session of a build mode. Accordingly, the user is able to select a database using database name 186 as shown in data source 176. In this case the data base is known as Opscape™.

The user then selects from selection table 188 one of the data tables from the data base (i.e. a subset of the data available within the database, or dataset) and from this picks a location to be assigned to the current node under the select category 190 which comprises several parameters such as in this example, hours deviation, hour sales division, sales sell hours, total hours, minimum hours and so on. Having selected the location category in the select category list 190, the user is able using the select sub-category listing 192 to select from an available set options such that the location might be selected as Brent Cross, here abbreviated as BrentCr.

The node 122 for the selected location is then displayed in the panel shown in the node preview section 178. This is confirmed in the node description section 180 which states that the node is from Brent Cross, but this section enables a user to make comments regarding the criteria selected for the node to inform other users of mapping details.

Turning to the data connection section 182, the elements which make up node 122 are presented in tabs 194, which here can be seen to show that there is a first sphere and a first cylinder (namely sphere_{—}1 and cylinder_{—}1).

The appearance properties of the element are then also shown in tabs 196, so that here colour and transparency of sphere 1 are seen to be available options. It should be noted however, that the appearance properties might comprise one or more of colour, transparency, size, geometry, diffusivity and specularity, as well as movement properties as well as flashing on and off, vibration and so on. Moreover, tabs 194 might also provide the user an option to select any connectors associated with a node and again the properties of the connector might also be selectable in the subsidiary sets of tabs 196.

Referring to FIG. 14, the colour properties for sphere 1 are shown. As can be seen from the data entry 198, the colour is associated with the data variable sales deviation as selected from the table of hours deviation, sales deviation, sales, sale hours, total hours, minimum hours, and so on. The data summary for the selected data entry of sales deviation in the table 198 preferably comprises firstly the earliest entry for available data (as shown at the top of section 200) then the latest date of the available data as shown in the second entry, the total number of records available between the earliest and latest entry (here 26), and user tools to select the start and end dates of the actual data to be shown in the data chart section 184 below. Preferably the start and end dates can be set using scroll buttons and/or a pop up calendar and/or by simply typing in the dates within the relevant sections. Finally, the total records within the selected start and end dates (and/or time etc) is then shown in the bottom panel of section 200. In the insertion 200 shown in FIG. 14 comprises the earliest entry of 5 Jul. 2004, the latest entry of 27 Dec. 2004 at 12.00 o'clock, total records of 26 and a start and end time for the graph shown in data chart section 184. Additionally, a total record selected a summary is provided which here is equal to the total records 26. The selected range of data is essentially a sampling distribution on the basis of which visualisation criteria can be set. In cases, for example, where there are many years' worth of data available, the user may only want to use the last year's or the last two years' data as the sample on which to set criteria.

Referring to data chart section 184, there is shown a graph 202 of the 26 records over the selected time frame. Using the graphical user interface, comprising a cursor for interacting with the view 172 on a display forming part of the computer system, the user is able to interact with the system thereby to set variables for changes in colour for the selected data entry 198 (here sales deviation). Using an interactive bar 204 which is provided against the Y axes of the data shown in the data chart 184, the user is able to position markers (or anchors) 206 on the Y axes for example providing a primary anchor marker here indicated at 0.076 which might be selected as a mean value in the data in the range shown, and then specify deviations about the anchor marker such as two further markers are provided at 9.4% deviation either side of the 0.76 anchor marker. Upper and lower markers are also inserted on the interactive bar 204 at +16% above the anchor marker and 15.1% below the anchor marker.

In one form the user is able to select the colour of each of the markers on the interactive mark 204 (for example using a right click and pop up menu) such that in one example, the anchor marker as 0.76 might be green, the intermediate upper marker at +9.4% might be orange and the upper marker at 16% might be red. Also, the intermediate lower marker at −9.4% might be a light blue (such as turquoise) and the lower limit at −15.1% might be a dark blue (such as navy blue). Accordingly, the sphere shown in node preview section 178 will be seen to vary colour in time, as indicated in the interactive horizontal bar 210, as the marker on interactive mark is moved (either by a user physically moving the marker and/or if it is moved automatically in running a view sequence) whereby data points below the minimum marker of −15.1% are shown as navy blue, data points falling between the −9.4% and −15.1% markers are shown in light blue, values between +9.4% and −9.4% of the anchor marker at 0.76, are shown in green, whereas data points between the intermediate upper marker at +9.4% and the upper marker of 16% are shown in orange, and finally, data points above the upper marker of 16% are shown in red. This then effects a bi-directional change in colour of the selected elements (here sphere 1) as the time is changed and as the data varies between the different selected mark positions within the range of data collected and being analysed. Preferably, the density of colour (and/or shade colour) can be varied by interpolation between the different marker positions. Accordingly, different shades of blue and red can be shown (preferably becoming deeper) as the data moves closer to the outer extreme position (+16% or −15.1%) compared to the intermediate upper and lower markers at +9.4% and −9.4% respectively.

Other elements associated with the node can be assigned with other appearance properties such as colour transparency, size and so as discussed earlier, in each of these appearance properties can be assigned a variable such as the variables shown in the data entries 198 (such as hours division, sales division and so on as already described). In the examples shown of having two elements, namely sphere 1 and cylinder 1, each having two variable appearance properties, namely colour and transparency, the user is able to select four variables associated with the selected sub-category for the node (here for example location of a sales office) and to assign variations in the visible properties of the elements according to variations in the variables whereby animation of the view of the node is possible when changing a known parameter such as time in order to analyse the available parameters and hence achieve variation in the appearance of the node in order to give an indication of that variation in data to the user in a visible and perceptible form.

The data summary section 200 enables the user to select the range of data to be analysed from the earliest and latest data. The user should actually select a suitable range to give a representative sample of variation in the selected parameter (here sales deviation) thereby to enable the user to appropriately set the markers 206 in the interactive bar 204.

In summary, view 172 shows that the data source panel 176 shows the data source data that was selected for this Build Mode session. Just below that, the user select a data table from the database, and from there pick a location to be assigned to the current mode.

Once the mode's location is selected, work moves to the top right panel. Here, the current node's geometry elements each have a tab pane (eg sphere_{—}1 and cylinder_{—}1). Within each geometry's pane there is a tabbed pane for each visual property of the geometry (eg colour, transparency) that can be connected to a data source variable.

Setting colour is the case shown in this slide. The idea behind the colour map used here is that is allows visualisation of bi-directional deviations of the data from an acceptable level (eg overshoot or undershoot in production level).

In the top right panel, sphere_{—}1 is the selected tab and colour is the selected tab within it. The scrollable list allows the user to pick a variable that will animate the sphere's colour. When the user clicks on a variable, the earliest and latest entries for that variable are retrieved and the total number of available data points is shown.

The user then chooses a time range for the sample of data based on which the mapping to the sphere's colour will be done.

The bottom right panel now shows a line chart of the time series within the sampled data time range. The user chooses an anchoring value (here 0.76) around which colours will be assigned. All values between the intermediate upper and lower (Red Min and Blue Maxi respectively) settings will be green. These values are deemed by a user/builder to be within acceptable deviation from the anchoring value of 0.76. Red is interpolated up between the red intermediate and red upper limited (Red Min and Red Max) and blue is interpolated up between lower intermediate and lower limited (Blue Min and Blue Max). Beyond Blue Min and Red Max, blue and red will be saturated, respectively. Next to the Red Min, Red Max, Blue Min and Blue Max, the percentage deviation from the anchoring value will be shown.

Based on these settings, the slider in the middle left panel can be used to see how animating the colour of the sphere will look over the sampled data time range. This is a View Mode preview just for this node. The bottom left panel can be used to write notes for View Mode users describing what data is being shown by which property of which geometry element, and what criteria have been set for visualisation.

Referring to FIG. 15, there is shown a further view 172 which is substantially similar to the data shown in FIG. 4 except that here, the transparency mapping of data to an element of the node. Again, the user selects an available data table 188 from the database. The user further selects a category such as location and then selects the appropriate sub-category such as Brent Cross. Accordingly, the node 122 for Brent Cross can be displayed in the node preview section 178 and the elements associated with that node displayed in the data connection section 182. Here details of the appearance properties and transparency 196 are shown in relation to element sphere_{—}1 as given at tab 194. The user selects a type of data from the data entries selection options 198 and here the user has selected hours deviation (in contrast to sales division shown if FIG. 14). Again the summary table 200 can be used to enable a user to select an appropriate time frame in which to observe representative data in the data chart section 184. A graph 212 is provided of the selected data range and the user is able to operate an interactive vertical bar 214 along the Y axes of the data graph 212. In this example, the transparency mapping is a unidirectional deviation indicator as provided between two markers 218 and 220. The markers represent the data value for which the element will appear maximally opaque (eg. 10% transparent) and maximally transparent (for example 80% transparent). Here, maximal opacity is set at a value of 0.4 (as indicated by marker 218 on slider bar 214) and maximally transparent at marker 220 having a value of 1.63. Between these two values, transparency interpolated. The check box R labelled 216, below the slider can be used to indicated whether lower or high values lead to more or less transparency (ie between 100% opaque and 0% opaque) or (0% transparency and 100% transparency) in other words on the extreme sides of the markers 218 and 220 on the Y axes of the data graph 212. Again, variation in the optical properties, or appearance, of the element can then be viewed by a user when the data varies according to the X axes (here time) is allowed to move in the node preview section 178.

However, such viewing at this stage is only to enable the user to determine whether or not the appropriate features of appearance of the element will be suitable in the circumstances, such as to enable determination of critical data for the specularity variable selected at the location, when the same user or other users use the data in the view mode, as described now in relation to FIGS. 16 to 20.

Referring to FIG. 16, there is shown a schematic flow diagram of the view mode start up process 230. At step 232, the user selects the view modes to start, and at step 234 the user selects the configuration file from a file chooser dialogue presented to the user via the system. At step 236, the user logs into the database required by the chosen configuration file and specifies a date time range at step 238.

At step 240 the user specifies whether the range is fixed or real time. If fixed, the view mode screen opens with model loaded and data connection established as shown at step 244 whereas if real time, the user specifies data update rate at step 242.

In summary, the view mode start up process 230 as shown in FIG. 16 provides a process simply for loading a configuration file previously created in a build mode to view information, such as business data relating to sales and sales operation for example, and to create a chart or tables of a subset of the data at locations and times that require further detailed attention. The view mode activity starts with selecting a configuration file. The user is then prompted to authenticate themselves for access to the data source associated with the chosen configuration file. Once these two steps are completed (steps 234 and 236) the user is asked to choose a date time range over which the data to be viewed spans. The user is also asked to specify whether the range will remain fixed without review throughout the viewing process, or whether it will keep moving forward in time as new data arrives in the data source (ie a real time application) as indicated at step 240. If a real time application, the user is asked to provide a frequency which the data source should be queried for new data as specified at step 242. The configuration is loaded (ie the 3D model is loaded and the attached data is accessed and stored in local memory) and control is given over to the user to interact and review the data and make charts and tables as needed as shown at step 244.

Referring to FIG. 17 a view 246 is shown of an example of a user display in the view mode 14 of the system according to the invention, wherein the current view configuration which is accessed for the display (248, is set out at the top of the view and a main display panel 250 is provided having a number of nodes 122 forming an interconnected array 24 of nodes.) Here, nodes represent geographical locations which might be interconnected for example through import and export routes. Six nodes are shown and designated with two designed codes for the relevant country with GB for the United Kingdom at the centre, US for the United States, JP for Japan, HK for Hong Kong, GR for Greece and FR for France being located around the GB node and interconnected with one another as shown. The display is generated since the configuration file is linked to a model file and accordingly the visual elements assigned to each of the nodes is displayed according to the data values as stored in the configuration file chosen by the user (as described earlier). The view mode enables the user fully to interact with the nodes and elements such as the user can rotate, zoom, reposition view points and so on using an interactive tool such as a mouse and key pad. Below the view panel 250, is an interactive bar 252 having a pointer 254 slideable along the interactive bar 252 for the user to vary the appropriate parameter such as time as shown here wherein the earliest date is 8 May 2002 and the latest date is 8 May 2006 thereby to vary the data associated with the nodes and hence vary the appearance of the elements and connectors associated with the relevant nodes (as described earlier). The user can pursue this for example using a click and drag mechanism using a mouse and cursor 256. If the date time range is fixed, as specified by the user at step 240 shown in FIG. 16, the chosen range variable to view is fixed by these end points. If the date time range is real time, the date time range covered by the interactive bar 252 keeps moving forward with the data update carried out at the specified time intervals as described in relation to 242 shown in FIG. 16.

Below the interactive bar 252, a series of buttons 258 are provided to enable the user to reset the data at the beginning of the range or to restore the viewpoint to the original location. Also, a video like control is provided in a play pause button 260 and leaping through the date time range is provided by button 262. Accordingly, the user can repeatedly review the change in appearance of the array 24 as the data progresses either through interactive use of the marker 254 on the interactive bar 252 or simply through pressing the play button 260, or by pressing the loop button 262 in order to have the sequence repeated in a loop thereby continuously to view the variation and better enable the user to determine any particular anomalies, or indeed a variety of anomalies which might need to be addressed which might otherwise not be apparent from review of the raw data itself. Finally, the user is able to adjust speed at which the view changes in panel 250 by use of the interactive time bar 264 which has a marker which enables the user to select a speed of review from slow to fast.

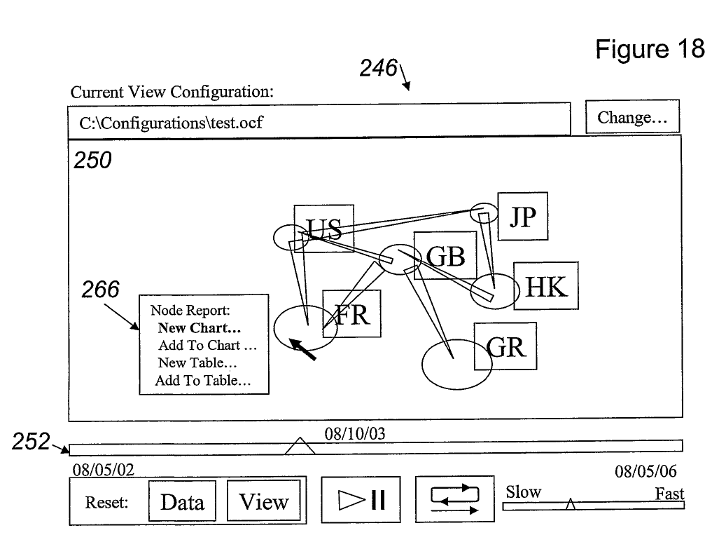

Referring to FIG. 18 view 246 is shown again, but on this occasion, the user has interacted with one of the nodes, here the FR (for France node) by placing the cursor over the node and for example by a right click on a mouse or say by pressing the shift key on a key pad thereby to bring up a pop up panel 266 which enables the user to perform certain actions on the selected node such as to create a new chart object, add new data to the existing chart object, create a new data table, easy for export and further analysis elsewhere, or add to an existing one.

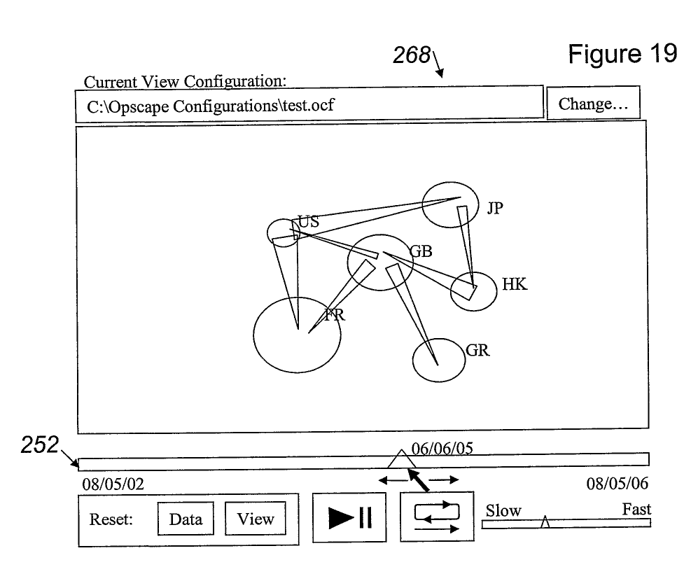

Referring to FIG. 19, there is shown a view to 68 similar to view 246 as shown in FIG. 18 except at a different time (or other variable associated with the interactive bar 252) such that it can be seen by way of example how the appearance of the nodes might vary according to a change in the variables represented by the interactive bar 252. Comparing FIG. 18 with FIG. 19 the date has changed from 8 Oct. 2003 to 6 Jun. 2005 and it can be seen for example that what appears in the grey scale views to be the tone (but in a colour view is the colour) of the nodes has changed. Moreover, the size of the spheres associated with each of the nodes has also changed in size such that the French and UK (GB) nodes can be seen to be considerably larger in FIG. 19 than they are in FIG. 18.

Referring to FIG. 20, there is shown a view 270 wherein a dialogue box 272 is provided in panel 250. The dialogue box 272 enables the user to create a new chart, for example through selection of the new chart option in the pop up 266 shown in FIG. 18.

In the top left hand corner of the dialogue box 272, is a node section 274 which enables selection of a node (or nodes) using a drop down feature (or menu) which enables a user to choose which node the variable values to be charted should come from. The default is the node from which the charting dialogue has been invoked (as in relation to use of the pop up panel 266 as shown in FIG. 18) and as indicated with the tick against the current node indicated in the nodes section 274. Below the node section 274 is a variables section 276 which provides a list of check boxes which shows all the variables associated with the selected node. Here, hours deviation and sales deviation are ticked and selected as shown in the chart section 278. However, any number of the variables from variable section 274 are selectable. By using the controls of the left panel together, the user can create a chart obtaining data from exactly the combination of variables required across all the variable node.

Beneficially, the chart section 278 provides a graph 280 showing the data values for the selected variables. There is also provided a key 282 regarding the indicators used in chart 280 of the variables and an interactive bar 284 comprising three sliders moveable along the interactive bar 204 (in the manner previously described such as using a mouse to operate a cursor shown in view 270). The interactive bar 284 can be used to vary the variable (series) parameter (such as date) representing the X axes in the graph 280 and accordingly the date time range selected for the graph 280 is variable using the interactive bar 284. The middle slider on the interactive bar 284 can be used to show the current date time in the view mode when the user selected a node and asked for the charting (ie 8 Oct. 2003 as selected in FIG. 18) and as represented by the crosses in circles in both lines in graph 280. The left and right sliders (or markers) can be set to give the range of which the selected variables should be plotted in the graph 280. Slider for 252 can be used to move the data range even further.

Beneficially, the user is therefore able to go easily from one visual representation of the data from the data source into a different graphical representation. That is, the user is able to review graphically a three dimensional model of the data and using the graphical user interface easily to select a key aspect of the data and to present that data in a different format, here a graph 280. Accordingly, the user is able to go from a schematic representation of the data into a more accurate representation of the data in the graph without actually looking at the tables of numerical values. The user is therefore able to analyse data in a much more natural and effective manner compared with simply analysis of tables of data.

Referring to FIGS. 21 and 22, an alternative embodiment of the user interface including main panel 120 is shown wherein in this embodiment elements are labelled using the same three digit reference (where possible) with an apostrophe suffix to distinguish them from the earlier embodiment. Here, FIG. 21 is most akin to the view shown in FIG. 5 and allows node positioning in a model, and FIG. 22 is most akin the node build mode view shown in FIG. 11.

Accordingly, using the same concept, an alternative embodiment of the node positioning interface is shown in FIG. 21. Instead of providing coloured planes and plane selector buttons to indicate how a horizontal and a vertical slider can be used to achieve node positioning in 3-D space, in this version, three orthogonal axes of the space are themselves drawn in three distinct colours (e.g., red, green and blue), and three separate sliders are provided along which a node's position can be changed. To move the node along a particular coloured axis, the slider of the corresponding colour needs to be manipulated. In this case, the viewpoint can be manipulated independently of the positioning functions by using a mouse model (e.g., left-button and drag to rotate, right-button to translate in the viewing plane, and middle-button to translate perpendicular to the viewing plane (i.e., in depth).

Accordingly, in a simple view in a model build mode of main panel 120′, a node 122′ is shown displayed relative to a three dimensional co-ordinate axis symbol 124′. Each axis in the axis sysmbol 124′ is preferably represented in a distinguishable graphical manner such by different colours as mentioned above.

Other buttons enabling editing and saving of configuration are shown having the same functionality as earlier. In this embodiment however, three separate slider or interaction bars/axes 132′ are provided rather than just two axes (see FIGS. 5 and 11 for example). Accordingly, axes 132a′, 132b′ and 132c′ are represented on the left-hand, bottom, and right-hand edges main panel 120′, each having a slider/marker/cursor 131′ enabling movement of the view of node 122′ shown in main panel 120′ through movement of the slider 131′ along its associated slider arm or axis 132′. Movement of a slider 131′ on its respective axis causes movement of the view and or position of a newnode 122′ in panel 120′ backwards and forwards along that axis as represented in the two dimensional view of panel 120′ in the three dimensional co-ordinate axis symbol 124′. Accordingly, a user is able to rotate the view (or position of a node 122′) completely in three dimensions using each of the axis 132a′, 132b′ and 132c′ and its associated slider 131′.

In a slightly modified form, of this and earlier embodiments, a second slider bar 132′ can be provided for eack axis preferably parallel with the first slider bar 132′ and representing the same representative axis (X Y or Z in the view of panel 120′) whereby one of the slider bars provides a course adjustment and the other provides a fine adjustment of the viewing/node placement position in panel 120′ and indeed in the position in the node build mode shown in FIG. 22.

In this version, a Node Editor button provides access to a node composition and editing tool as shown in FIG. 22. New nodes can be created, and existing nodes can be edited using this tool accessed from the main builder window (using the Node Editor button as in the previous figure). Here, clicking any of the available shapes from the scrollable list on the left-hand side places that shape in a node builder space. The controls for changing the viewpoint as well as the positions of the node elements is the same as in the main builder window (except that the coordinate system shown by the axes is local to the node itself). Once the required composition of shapes is achieved, the created node-type can be saved and added to configuration being created in the main builder window. Equally, an existing node type can be retrieved (from the list appearing on the top), edited and added to the configuration in the main builder window. In use, this window appears as a movable overlay on top of the main builder window.

Referring to FIG. 22, a node build panel 154′ is shown. Here, a selection of buttons 158′ are provided enabling association of specific geometries with a node 122′, the shapes being assigned the same three digit reference numbers used earlier here suffixed with an apostrophe. In this view shown in FIG. 22, beneficially a range of geometries are selectable from a large number of buttons 158′, the view being variable to show more than the four shapes shown in FIG. 22 by scrolling cursor 159′ up and down the view enabling different geometries to be viewed by the user and hence selected and associated with node 122′. Here, slider bars 132a′, 132b′ and 132c′ are also shown having cursors 131′ enabling the movement and positioning of the node 122′ within the view 154′.

Use of selection buttons 134′ in FIGS. 21 and 22 enable the user to simply select 1, 2 or 3 of the axis to enable rotation and/or placement (depending on the mode) of the view in the associated panel. Hence, by deselecting the X axis button for example the slider bar, eg 132a′ which might be associated with the X axis can be deselected and hence movement of cursor 131′ either fixed and/or if moved, disassociated from actual movement of the view in the view.

1. A method in a computer of building a visual representation model for presenting plural forms of data from a data source to a user, comprising the steps of creating a first file of data (model file) representative of one or more physical attributes of one or more elements associated with one of a plurality of nodes in the visual representation, creating a second file of data (configuration file) representative of visual attributes of the one or more elements for each of the plurality of nodes in the visual representation and associating a variation in the visual appearance of the nodes in correlation with variation in the data from the data source which is associated with the nodes.

2. A method of building a visual representation model according to claim 1 wherein the data source comprises data for one or more variable(s), the data for the one or more variable(s) being available for two or more first categories (such as different sites or components) of data and the data having a common parameter (such as time or mileage) across the two or more first categories of data, thereby to enable comparison of the data for the different first categories through variation of the common parameter.

3. A method according to claim 1 wherein the user is able to associate one or more variables from a first category with a node.

4. A method according to claim 3 when a user is able to associate a second category of data (such as location or machine) with the first file of data.

5. A method according to claim 1 further comprising the steps of generating a plurality of nodes viewable to a user via a graphical user interface which nodes vary in appearance in accordance with associated data in the data source.

6. A method according to claim 1 adapted to enable a user to position an array of nodes relative to one another in a three dimensional model which is representable in a variety of views to the user on a two dimensional display.

7. A method according to claim 6 wherein a position of a node in three dimensional co-ordinate space (or model) is represented in a two dimensional view relative to a reference (such as three orthogonal axes) of the three dimensional space.

8. A method according to claim 7 wherein the location of the node can be set visually by a user interacting with the view of a node in a graphical user interface whereby the node is positionable on a two dimensional view of each of three orthogonal planes of the representative three dimensional co-ordinate space in turn.

9. A method according to claim 6 wherein the orthogonal planes are identified in the user display using different colours.

10. A method according to claim 8 wherein the user is able to select the plane in which a node is to be positioned through a graphical user interface by one or more of selecting a button to bring up the two dimensional plane (with the third axis perpendicular to the display), interacting with a co-ordinate reference (for example by selecting a representative plane between adjacent axes), and selecting a separate positioning plane view from the graphical user interface.

11. A method according to claim 6 wherein the node is positionable within a plane by at least one of dragging and dropping the node within a view of the plane, typing in co-ordinates with the under plane and using interactive bars representative of the co-ordinates for the two axes of the plane (such as X and Y axes)

12. A method according to claim 1 further comprising the step of enabling a user to associate a connector between two nodes to provide a visual representation of data associated with the connected nodes.

13. A method according to claim 12 wherein the user is able to generate a connector (for example through clicking on an appropriate button in the graphical user interface) and to associate the connector thus generated with two nodes through the graphical user interface by selecting a first node and then selecting a second node whereafter the display shows a connection between the selected nodes.

14. A method according to claim 1 wherein the user is able to associate one or more elements with a node through a graphical user interface.

15. A method according to claim 14 wherein the user is able through a graphical user interface to do at least one of selecting one or more geometrical shapes to represent the element, position the orientation of an element relative to the node, and to position an element in three dimensional co-ordinate space relative to the position of the node.

16. A method according to claim 14 wherein the element and/or text associated with the element and node can be assigned the attribute of having the same elevational view independent of the actual view in the three dimensional co-ordinate space which the user might select of the node (billboard view).

17. A method according to claim 1 wherein a user is able to associate data with one or more elements associated with a node through the a graphical user interface.

18. A method according to claim 17 wherein the user is able to associate variables with an element associated with a node through the graphical user interface.

19. A method according to claim 18 wherein the user is able to associate a variation in appearance of an element associated with a node in accordance with a change or scatter in a variable through a graphical user interface.

20. A method according to claim 19 wherein the variation in appearance includes one or more of size, colour, transparency, opacity, specularity, shape, geometry, orientation, position, and density of colour.

21. A method according to claim 20 wherein the graphical user interface enables the user to define a bi-directional change in appearance (colour, tone and/or density) and preferably in a direction of variation of data about a user determined position.

22. A method according to claim 20 wherein the graphical user interface enables a user to select ranges of data values having at least one of pre-assigned colours and/or density of colours thereby to enable tonal variations in colour or densities of colour dependent on the users selected ranges for a variable, and preferably wherein the variation in the appearance is interpolated depending on the value of the associated data relative to the selected range or positioning, more preferably the user is able to select an anchor position which preferably is an absolute value selected from within the range of values of the data, and more preferably the range of data values is selectable using one or more markers (such as sliders on an interactive bar) wherein the one or more markers are postionable based on a relative value (such as a percentage) of the anchor value.

23. (Currently) A method according to claim 22 wherein the graphical user interface is adapted to enable a user to insert a range of transparency against a range for a selected variable and preferably the range is determined by two markers insertable against the variable data in order to fix the values of an upper and lower limit of transparency, such as 20% transparent (or 80% opaque and 80% transparent (or 20% opaque).

24. A method for viewing variation in data with respect to a known parameter (such as time) for different categories of data (such as specific geographical locations) comprising the method of claim 1 and further comprising a step of displaying an element associated with a node representative of the category of data which element has the properties of one or more of shape, orientation, colour, transparency, and displaying variation in the appearance of the element associated with a node as the parameter is varied thereby to provide a variation in the relative appearance of the nodes displayed.

25. A method according to claim 24 comprising a graphical user interface which enables a user to select one or more of the speed of variation of the common parameter, the specific points within a range of the parameter, the start and end position of the variation of the parameter to be viewed, a view which loops through the range of the parameter to show the animated variation of the data represented through the nodes and elements associated therewith, and speed of movement through the parameter range.

26. A method according to claim 25 wherein the user is able to generate a graph of the data for the variables being represented in the animated view of the data shown through the graphical user interface.

27. A method of positioning a node in a three dimensional model of one or more nodes, comprising the steps of: building a visual representation model according to claim 1; displaying a view representative of the three dimensional model to a user via a graphical user interface; enabling selection of a two dimensional plane by the user; and enabling movement of the node in the selected two dimensional plane.

28. A method according to claim 27 comprising the step of a symbol representative of the axes in the three dimensional model in the view thereof.

29. A method according to claim 28 wherein the symbol comprises three orthogonal axes.

30. A method according to claim 29 wherein the symbol comprises an element associated with three orthogonal pallet planes.

31. A method according to claim 28 wherein they symbol comprises a distinctive region (such as coloured) for each of three orthogonal planes and preferably wherein the distinctive region is provided between orthogonal axes thereby to distinguish each of three planes in three dimensional space.

32. A method according to claim 27 wherein the user is enabled via the graphical user interface to select a two dimensional plane within the three dimensional model, and preferably wherein a button is provided for three orthogonal planes in the three dimensional model.

33. A method according to claim 32 wherein the graphical user interface provides an interactive bar enabling location of a node along an axes in the three dimensional model by positioning a slider along the interactive bar.

34. A method according to claim 33 comprising two sliders, preferably perpendicular to one another in the display, representative of perpendicular axes in the selected plane and enabling location of a node in the view relative to each of the perpendicular axes.

35. A method according to claim 27 wherein the orientation of the view representative of the three dimensional model to the user is varied upon selection of a two dimensional plane by the user and preferably wherein the plane of the view changes to be one which is parallel with the selected two dimensional plane (such that the selected two dimensional plane is parallel with the screen of the display for example).

36. A method according to claim 27 wherein the view representative of the three dimensional model does not change when the user selects a two dimensional plane, and preferably wherein the representative view is a three dimensional representative view.

37. A method according to claim 21, wherein axis interaction is enabled for at least one of (and preferably each) of one or more (and preferably three orthogonal) axes represented in a two dimensional view of the visual representation model, wherein a graphical user interface enables a user to interact with the axis thereby to adjust the two dimensional view, to cause relative movement of the model or the position of a node in the model for example, in accordance with the user interaction with the axis selected by the user.

38. A method according to claim 37 wherein axis interaction means comprises a slider bar and a slider movable along the bar.

39. A method according to claim 37 wherein the axis interaction is enabled by a first course adjustment and a second fine adjustment.

40. A method according to claim 39 wherein the first course and second fine adjustment comprise substantially parallel interactive slider bars.

41. A method according to claim 37 wherein three slider bars are provided for three orthogonal axes represented in the view, preferably the slider bars are positioned adjacent different edges of the view and more preferably adjacent left side, bottom and right side edges of the view.

42. A method according to claim 37 wherein the view comprises a symbol representative of the one or more axes within the view and wherein the axis interaction means for an axis is represented in a graphically manner visually linking the axis interaction means with the associated axis in the symbol.

43. A method according to claim 42 wherein at least part of an axis within the symbol and at least part of an axis interaction means associated with the axis are the same colour.

44. A method according to claim 37 wherein in a model build mode the view is moveable relative to a fixed coordinated axes for a model within the view, and or wherein in a node creation or editing mode the view and or node is movable relative to a fixed coordinate axes associated with the node.

45. A user interface adapted in a computer system to enable ease of location of an node within a two dimensional representation on a display of a three dimensional space, comprising representation of planes of three orthogonal planes within the three dimensional space on the two dimensional display, a user input mechanism enabling the user to select one of the three orthogonal planes and to locate the object on that plane, the user subsequently being able to select one of the two other orthogonal planes and to move the object in the selected plane or a plane parallel with it.

46. A user interface according to claim 45 wherein the user is also able to select the third of the three orthogonal planes and to move the object in the selected plane or a plane parallel with it.

47. A user interface according to claim 46 wherein, when a plane is selected, the object is constrained to move exclusively within the selected plane or a plane parallel to it as represented in the two dimensional view of the three dimensional orthogonal planes.

48. A user interface according to claim 45 wherein the planes are represented in different visual manners.

49. A user interface according to claim 48 wherein the orthogonal planes are each represented by a different colour.

50. A user interface according to claim 45 enabling selection of representational properties, such as shape, colour, and transparency, to be associated with a node represented in the interface.

51. A user interface for a user to build a data representation system according to method claim 1.

52. A computer system adapted to build a visual representation model of plural forms of data from a data source comprising means for performing the steps of claim 1.

53. A computer useable product comprising instructional data which when operated on by a computer enable the computer to perform the steps of claim 1.
